(19) United States
(12) Patent Application Publication
(10) Pub. No.: US 2023/0316949 A1
(43) Pub. Date: Oct. 5, 2023

(54) COMMUNICATION SKILLS TRAINING

(71) Applicant: Yoodli, Inc., Seattle, WA (US)

(72) Inventors: Esha Joshi, Seattle, WA (US); Varun Puri, Seattle, WA (US)

(21) Appl. No.: 17/657,731

(22) Filed: Apr. 1, 2022

(51) Int. Cl. G09B 19/04; G09B 5/02

(52) U.S. Cl. CPC G09B 19/04; G09B 5/02

(57) ABSTRACT

The disclosed communication skills training tool analyzes visual or vocal content of data relating to a communication event. A user performs in a communication event and the words spoken are analyzed by the disclosed systems and methods. The analyzed visual or vocal content is compared to a communication standard or goal. Recommendation output is generated based on the compared or analyzed visual or vocal content.

### CROSS-REFERENCE TO RELATED APPLICATIONS

This application is related to U.S. Non-Provisional application Ser. No. ______, entitled, ______,” filed ______, which are incorporated herein by reference in their entirety for all purposes.

### BACKGROUND

Communication can be challenging for many people, especially in pressure situations like public speaking, interviewing, teaching, and debates. Further, some people find communication more difficult in general because of a language difference, a personality trait, or a disability. For example, a nervous person may often use filler words, such as “umm” and “uhh” instead of content rich language during the communication or may speak very quickly. Other people may have a speech impediment that requires practice or may have a native language accent when they wish to communicate with others of a differing native language. Even skilled public speakers without physical or personality barriers to communication tend to develop communication habits that can be damaging to the success of the communication. For example, some people use non-inclusive language or “up talk” (raise the tone of their voices at the end of a statement rather than a question).

Because communication is such a critical skill for success across all ages and professions, some people choose to engage with communication improvement tools such as communication or speech/speaker coaches or skill improvement platforms to help them improve their communication skills. These tools tend to track metrics like pace, voice pitch, and filler words but lack an ability to drive real skill specific growth. Rather, they tend to be good at helping users rehearse specific content but not at improving their underlying communication skills. Such coaches and platforms tend to be communication event specific—rehearsing for a speech, for example—rather than targeting improvement in a particular communication skill People who engage with these coaches and platforms find they improve their presentation for their intended specific purpose but lack the growth they would like to enjoy by improving the foundational skills that are ubiquitous to all flood communication.

What is needed in the industry is a tool for improving communication skills that allows users to enhance their foundational communication abilities.

### BRIEF DESCRIPTION OF THE DRAWINGS

Non-limiting and non-exhaustive embodiments of the invention are described with reference to the following drawings. In the drawings, like reference numerals refer to like parts throughout the various figures, unless otherwise specified, wherein:

FIG. 1 is a flow diagram for training users on communication skills.

FIG. 2 shows a system diagram of an example communication skills training system.

FIG. 3 is a flow diagram of helping users adjust position to improve communication skills.

FIG. 4A is an example of an output of a display with position adjustment recommendations that help users adjust position to improve communication skills.

FIG. 4B is an example an output of a display that helps a user maintain proper position to improve communication skills.

FIG. 5 is another example of an output of a display that can have position adjustment recommendations for users.

FIG. 6 is a flow diagram of an example method of training users to improve communication skills with verbal content.

FIG. 7 is a flow diagram of an example method of training users to improve communication skills with visual or vocal content.

### DETAILED DESCRIPTION

The subject matter of embodiments disclosed herein is described here with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described.

The disclosed systems and methods train users to improve their communication skills. Communication is critical to every facet of success in life so it touches all human beings whether they communicate with small groups or in front of large crowds. People suffer from various factors that substantially affect their ability to communicate effectively including stage fright, medical conditions, language barriers, and the like. Some people who wish to improve their communication skills hire expensive communications coaches or spend hours in groups designed to help improve an aspect of communication, such as public speaking. Often, these people who engage in the hard work to improve their communications skills tend to have a particular event in mind for which they wish to prepare. That results in an event-specific outcome for those people.

For example, a person hires a communication coach to help them prepare for an important speech. They practice with the coach for months, working on the structure and content of the speech itself, nervous ticks, bad speaking habits or posture, and the like. At the end of this work, the person has a more polished speech ready to give because of the intense, repetitive practice they did specific to the particular speech to be given and the venue at which it is to be given. The person also might enjoy some incremental improvement in their general communication skills as a result of the immense amount of practice. However, that person was never focused on improving the communication skill itself, but instead was focused on improving the quality of a single speech or communication event. The person might receive feedback from the communication coach that they say filler words or hedging words too often, slouch their shoulders when they become tired, or speak too quickly when they are nervous. However, the coach is unable to given them tangible, data-driven feedback that is focused on verbal, visual, and vocal content of the person's communications skills rather than a single performance.

The disclosed systems and methods provide users with feedback over time on the verbal, visual, or vocal content of their communication skills. Verbal content includes the words actually spoken by the person—the content and its organization. For example, verbal content includes non-inclusive language, disfluencies (e.g., filler words or hedging words), specific jargon, or top key words. Specifically, disfluencies are any words or phrases that indicate a user's lack of confidence in the words spoken. Filler words such as “umm” or “uhhh” and hedging words such as “actually,” basically,” and the like tend to indicate the user is not confident in the words they are currently speaking. Any type of disfluency can be included in verbal content or a grouping of disfluencies multiple types or as a whole category can also be included as verbal content. Visual content includes the body language or physical position, composure, habits, and the like of the user. For example, visual content includes eye contact, posture, body gesture(s), and user background(s)—the imagery of the audience view of the user, the user's motion(s) and movement(s), and their surroundings or ambient environment. Vocal content includes features or characteristics of the user's voice, such as tone, pitch, volume, pacing, and the like. The disclosed system and methods can be powered by artificial intelligence (AI) that compares a current input content to previously stored content—either user stored content or content from a sample, such as a speaker that is excellent in a desired skill of focus for user. Standard AI techniques can be used to compare a current content sample to the existing content. When the current content sample is compared to a user's prior content, the user can begin to learn where they are improving (or not) over time. Their progress can be tracked, and they can set goals and standards they wish to meet based on the comparison of their content to past content.

In the example in which the user's current content is compared to a speaker that has a good communication skill the user wishes to learn, emulate, or adopt, the user's current content can be compared to the exemplary speaker in at least one feature or characteristic, such as tone, up talk, physical presence or position, filler or hedging word rate, or any other verbal, visual, or vocal characteristic.

The user, third parties, or a content analysis algorithm provide feedback to the user on the content provided. The user can input feedback about their own content by replaying the content or adding notes into the disclosed system. Third parties can do the same. The content analysis algorithm also generates feedback from the user's content. This feedback can be asynchronous with or in real-time during the communication event. In some systems, some of the feedback is asynchronous and other feedback is output in real-time to the user. For example, the content analysis algorithm provides real-time feedback to the user while the user reviews the content after the event concludes. Third party mentors and friends can provide their feedback in both real-time and asynchronously in this example.

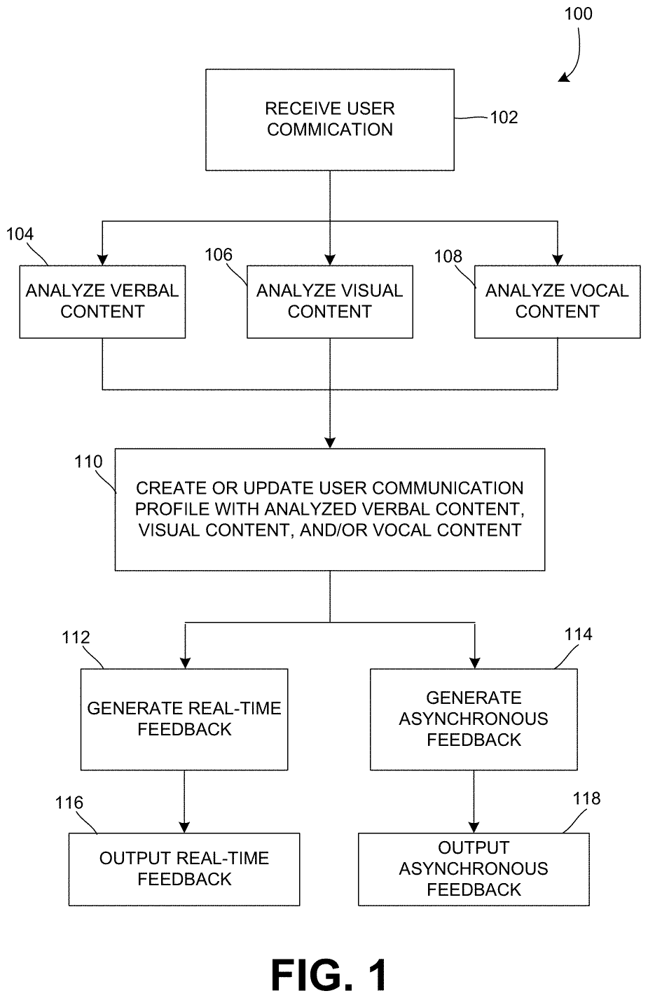

Turning now to FIG. 1, an example communication skills training system 100 receives user communication 102 that can include verbal content, visual content, or vocal content. In some examples, the user communication 102 that the system receives in a combination of multiple types of content. Verbal content includes the substantive words spoken by a user, which can include the user's word choice, such as non-inclusive language, disfluenc(ies), jargon, and top key words. Visual content includes the user's physical position, eye contact quality, posture, gestures or movement, body language, and appearance. Vocal content includes the sound quality and characteristics of the user like the user's voice volume, pitch, and tone, and the user's general speech pacing. The system then analyzes the received user communication by analyzing the verbal content 104, analyzing the visual content 106, or analyzing the vocal content 108, depending on the type of data the system received in the user communication 102.

The system maintains a user profile for each user. In this example, the system creates a new user profile 110 if the user communication relates to a user that is not already stored in the existing system library of user profiles. The system makes this determination is any conventional manner, such as comparing user identification information to user communication data stored for multiple users that have already input user communication data. The system can store any suitable number of user profiles, as needed. When the system determines that received user communication relates to an existing user profile, it updates the user profile 110 with the new user communication in the respective category—verbal content, visual content, vocal content, or some combination of these types of content (correlating with the type(s) of information that was received in the user communication). The update 110 allows the AI algorithm to incorporate the analyzed user communication into the user profile so the system can generate empowered feedback. AI algorithms of any kind can be used for this purpose—any AI technique that is able to discern differences between the existing data set in the user profile and the new data set in the analyzed user communication can be used. Over time, the AI algorithm can discern between increasingly smaller differences between the existing user profile data set and the analyzed data set to fine tune the generated feedback.

After the AI algorithm produces differences between the analyzed data and the existing data set for the user profile, the system then generates either real-time feedback 112 or receives or generates asynchronous feedback 114. The real-time feedback 112 is generated by the system and then output 116 to the user during a live communication event. The real-time feedback 112 can also be received from third parties and integrated with the algorithm feedback in another example. Third parties can include human coaches or other audience members and third party algorithms. The third party data can be output to the user in real-time 116 either integrated or compiled with the algorithm data or as separately output data. In an alternative example, the algorithm is not triggered to active or analyze any user communication data, but instead the third party data is received or analyzed by the system and output to the user in real-time 116.

The asynchronous feedback 114 is generated by the AI algorithm or received from a third party in a similar way to the real-time feedback but is instead output to the user after the communication event ends 118. In this example, the third party feedback may not be analyzed by the system and could simply be passed through and compiled with the AI algorithm feedback or simply output to the user in the form in which it was received by the system.

The user can also input asynchronous feedback to the system about their own communication event, such as a self-reflection or notes for growth or edits to content, for example. In this example, the system can ingest any one or multiple of AI algorithm analyzed data and feedback, third party analyzed data and feedback, or user analyzed data and feedback relating to the user's communication event. Like the real-time feedback, in an example in which asynchronous feedback is received from multiple sources—the AI algorithm, third parties, or the user—the feedback can be analyzed and output 118 separately or can be integrated and analyzed in groups or sub-groups, as needed.

In some example systems, the system can output both real-time 116 and asynchronous feedback 118 to the user in any of the forms of data that was received or analyzed. Here, the system would output the real-time feedback 116 during the communication event and the asynchronous feedback after the communication event 118. The real-time feedback during the communication event can differ from the type and substance of the asynchronous feedback after the event because of the source of the received data (AI algorithm, third party, or user) and the depth or type of analysis performed by the system on the received data.

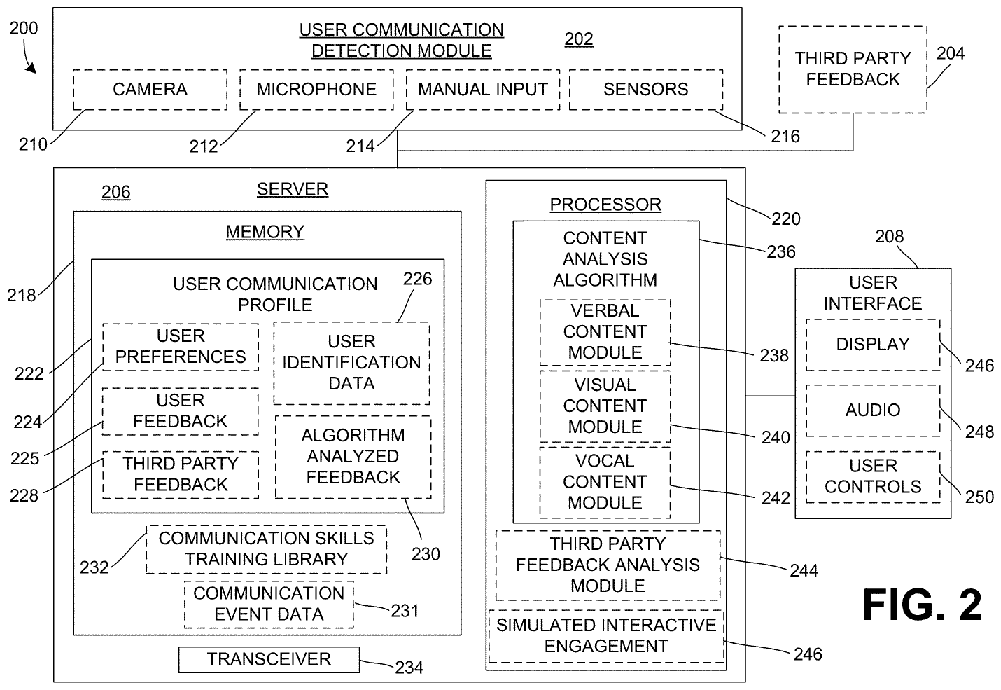

FIG. 2 shows an example communication skills training system 200 that includes a user communication detection module 202, third party feedback 204, a server 206, and a user interface 208. The user communication detection module 202 and third party feedback 204 generate or receive the data that is input to the communication skills training system 200. The user communication detection module 202 includes a camera 210, a microphone, 212, a manual input 214, and one or more sensors 216 in this example. The camera 210 can be any optical imaging component or device. For example, the camera 210 can be an optical imaging device or multiple devices that capture(s) either or both of still and video images of a user during a communication event. The microphone 212 is any suitable device that can capture audio of the user during a communication event. The manual input 214 is any suitable device that can receive input from a user or third party, such as a user interface having any desired feature(s) like text or voice input, touchscreen editing, or other capabilities. The sensor(s) 216 in this system can be any suitable sensor that detects a parameter or feature of the ambient environment of the communication event, such as lighting and image object detection for positioning or other feedback, for example.

The user communication detection module 202 can also include or integrate with third party systems that ingest user data that is transmitted to the communication skills training system 200 shown in FIG. 2. For example, the system 200 integrates with a 3-D video image capture system that captures real-time 3D video or imaging of the user during a communication event. The system 200 may or may not also have its own video capture system. Regardless of the video capture capabilities of the system 200, the system 200 integrates the data received from the third party system—in this case, the 3D video imaging of the user—for analysis and to incorporate into the real-time or asynchronous feedback it generates for the user.

The server 206 of the communication skills training system 200 has a memory 218, a processor 220, and a transceiver 234. The memory 218 stores various data relating to the user, third party feedback, a library of comparison data relating to communications skills training, the algorithms applied to any data received, and any other data or algorithms relating to or used to analyze data regarding training users on communication skills. For example, the memory 218 includes a user communication profile 222 in the system shown in FIG. 2. The user communication profile 222 includes various data relating to a user of the communication skills training system 200. A user communication profile 222 can be created for each user of the communication skills training system 200 in example systems that train multiple users. The user communication profile 22 includes user preferences 224 and user identification data 226. User preferences 224 includes data relating to features, goals, skills of interest, and the like that the user inputs into the system and that may be part of the data analysis that generates feedback in one or more categories or for one or more communication skills. User identification data 226 includes any data that uniquely identifies the user, such as a user's bibliographic information or biometric data for authenticating a user to the system, for example. The user communication profile 218 also includes user feedback 225 and third party feedback 228, which can be received by the communication skills training system 200 either in real-time or asynchronously, as discussed above. Such feedback can include time stamped notes that include observations about or suggestions or recommendations for improvement on a particular segment of a communication event or generalized observations about or suggestions or recommendations for improvement on the overall communication event.

The user communication profile 222 also includes algorithm analyzed feedback 230, as shown in FIG. 2. The algorithm analyzed feedback 230 can be provided in real-time or asynchronously like any of the other feedback provided to the user communication profile 222. The algorithm analyzed feedback 230 includes observations, metrics, and suggestions or recommendations generated by a content analysis algorithm 236, discussed more below, that is part of the communication skills training system 200. As part of the algorithm analyzed feedback 230, the communication skills training system 200 can include a game, such as user challenges regarding a particular communication skill of interest or focus for improvement or practice. The gamification of improving the user's communication skill of interest or focus can be compared against the user's performance in a previous communication event (or multiple previous communication events) or can be compared against others in a social network or against skilled communicators, such as famous people or experts or any combination of these comparisons.

The memory 218 also includes a communication skills library 232 that can include skilled communicator examples that include data relating to one or more video or image segment(s) of skilled communicators. They can be used to train a user by simply allow a user to replay a video of a skilled communicator, such as a famous person or an expert. This library content 232 can also be used as a comparison tool to evaluate against a communication event of the user. The library content can also include examples of poor communication skills, if desired, to show or evaluate a user's performance on defined objective or created subjective measurements of skill level or improvement or growth.

The processor 220 of the communication skills training system 200 shown in FIG. 2 includes a content analysis algorithm 236, as mentioned above. The content analysis algorithm 236 receives communication event data and analyzes it, such as by identifying certain parameters or characteristics, generating metrics, evaluating or quantifying certain aspects of the data, and the like. In the example shown in FIG. 2, the content analysis algorithm 236 includes a verbal content module 238, a visual content module 240, and a vocal content module 242 that each analyze data relating to respective verbal content, visual content, and vocal content detected by the user communication detection module 202.

For example, the verbal content module 238 can identify top key words or generate a transcript of the communication event. For example, the verbal content module 238 can identify certain words like hedging words (e.g., basically, very, actually, or basically) or non-inclusive words and provide real-time and post-event asynchronous feedback on such metrics. Still further, the verbal content module 238 can identify words that the user emphasizes by pausing or changing the pace of the word as it is spoken, for example. Such verbal metrics can be mapped to a substantive structure of a user's communication event that is either predetermined or generated post-event.

A user could, in an example, upload an outline of key points to address in the communication event. The verbal content module 238 can then map key words it identifies during the communication event to each key point in the uploaded outline and provide metrics to the user either in real-time or post-event regarding the frequency, depth, and other measures relating to the user addressing the key points of the outline. This can also be blended with the verbal content module 238 tracking filler words, such as “uhhh” or “ummm,” either as a standalone metric or in combination with the key points of the outline to see during which of the key outline points the user said more filler words. The verbal content module 238 can measure and analyze any data relating to the content spoken by the user.

The verbal content module 238 can also output reminders in response to tracking the verbal, spoken content and word choice. Output reminders can be generated and output to the user in real-time during the communication event. For example, if a user is repeating themselves over a particular allowable threshold—identified in similarity by techniques such as natural language processing or keyword detection—the system 200 then triggers an output to the user during the event that the user should progress to the next topic or point in the communication. In another example, the verbal content module 238 can identify a missed point the user wished to make during the communication event based on a pre-defined set of points the user wanted to address during the communication event. If a missed point is identified by the verbal content module 238, then it generates a user prompt to note the missed point and optionally suggest to the user a time or way to bring up the missed point later during the communication event. The suggestion could be timed based on a similarity of the missed point to another point the user wished to make during the communication event that would be part of the pre-defined set of points the user wanted to address.

Even further, the verbal content module 238 can track a user's point for introduction, topics and sub-topic points, supporting evidence or explanation, and conclusion. This tracking can be done by either comparing the verbal content received with the pre-defined content the user inputs or against common words used for introductions, argument or point explanatory development, and conclusions, for example. The tracking can also be used to help prompt a user to move on to the next phase of the point—move from introduction to explaining detail for a first topic, for example. The system can start by identifying key words typically associated with introductions. If the system tracks that the user speaks too many sequential sentences that include typical introduction key words, then the verbal content module 238 can generate a user prompt to encourage the user to progress to the next portion of the point. This can be accomplished by detecting a number of introduction sentences that exceed a threshold, for example, such as three or more sentences identified as introduction content. When the system detects that the user has exceeded the threshold number of introduction sentences, it triggers a user prompt to progress the content to the next portion of the point.

Still further, the user's pre-defined content, such as speaking notes for example, can be mapped to the user's real-time verbal content. The communication skills training system 200 can display an outline of the pre-defined content that is visually shown as having been addressed or not yet addressed during a communication event. Each point in the pre-defined content can be marked addressed or not addressed during the communication event, which appears on the display seen by the user. The display of this tracking of pre-defined content gives the user a visual cue on the remaining content to discuss during the communication event.

In an example, the verbal content module 238 creates a real-time or post-event transcript of the user's verbal content—the precise, ordered words spoken—during a communication event. If the verbal content module 238 creates a real-time transcript, it can also display it for the user or third parties during the communication event. For the post-event transcript example, the transcript can be edited by the user or a third party and can be optionally displayed in simultaneous play with a video capture replay of the communication event. In some examples, the communication skills training system 200 creates both a real-time and a post-event transcript.

The visual content module 240 can identify visual features or parameters of the user during the communication event, which can include the user's position within a speaking environment for example. The user's position can be on a screen if the communication event occurs virtually or can be within a particular ambient environment for the user during a live event. The visual features or parameters can also include body language and position, such as gestures, head tilt, crossed arms or legs, shoulder shrug, body angling, movements typically associated with a nervous demeanor (i.e., foot or hand tapping, rapid eye movement, etc.), and the like. The visual content module 240 can compare captured frames received from the user communication detection module 202 with prior frames of a similar or time-mapped segment of a prior user communication event. Alternatively or additionally, the visual content module 202 can track visual content throughout the entire communication event and compare it to a prior event, an expert event, or a famous person's prior communication event.

The user communication module 226 stores the communication event data 231 feedback produced by the content algorithm 236 and the third party feedback analysis module 244. Users or third parties can access the stored communication event data 231 about any one or more communication events. For example, the stored communication event data 231 can be video and transcripts of multiple communication events. The user and any authorized third parties can access that stored communication event data 231 to analyze it for feedback. Some examples allow the user or third parties to manipulate the stored communication event data 231 by applying edits or changes to any of the stored communication event data 231 when it is replayed or reviewed, such as removing or decreasing filler words, increasing or decreasing the speed of the user's speech, adding or removing pauses, and the like.

The communication skills training system 200 can also include a simulated interactive engagement module 246. The simulated interactive engagement module 246 includes a simulated person or group of people with whom the user can simulate a live interaction during the communication event. For example, the simulated person could be an avatar or a simulated audience. The content analysis algorithm 236 includes a feature in one or more of its verbal content module 238, visual content module 240, or vocal content module 242 that detects spoken language cues or body language that the system then equates with a likelihood that another person, group of people, or an audience would react in a positive, constructive, or negative manner. For example, if the user is talking too fast (measuring speech speed) or repeating the same point several times (key word detection), the verbal content module 238 would detect the speed of the user's speech or the key word frequency is above a threshold rate or value. If the speed or key word frequency breeches the threshold, the verbal content module 238 generates an avatar or members of a simulated audience, for example, to appear to be confused or disengaged. If the user is instead maintaining the speed of their speech within an optimal range and mentioning key words at an optimal frequency, the verbal content module 238 generates the avatar or members of the simulated audience to appear engaged and curious.

The same concept can be applied to the visual content module 240 and the vocal content module 242. The simulated avatar or audience can appear to react in a manner that correlates to the analyzed data relating to the user's body language, position, and movements and also to the users' vocal features and parameters like the user's voice volume, pauses, tone, and the like.

This same simulated interactive engagement module 246 can be useful for training users in multiple types of communication events. The user may wish to practice for an interview, for example with one or more other people. The communication skills training system 200 can receive input from a user about an interview, such as a sample list of topics or interview questions. The simulated interactive engagement module 246 poses the list of questions or topics to the user in a simulated live communication event. As the user progresses through the list of sample questions or topics, the simulated interviewer(s) can be instructed by the simulated interactive engagement module 246 to respond differently depending on the user's metrics in a pervious question or topic. For example, the simulated interactive engagement module 246 tracks key words that a user selected to answer a first question. If the user exceeded a threshold value of the number of times or the variation of the key words used, for example, the simulated interviewer(s) could respond with a pleasant smile or an approving nod.

The transceiver 234 of the server 206 permits transmission of data to and from the server 206. In the example shown in FIG. 2, one or more of the user communication detection module 202, the third party feedback 204, and the user interface 208 can be integrated into a single system. Alternatively, one or more of the components can be a remote component, such as the third party feedback algorithm 204 discussed above or an output that is positioned remote from the memory 218 and processor 220 in a distributed computing environment.

The communication skills training system 200 also includes a user interface 208 that has a display 246, an audio output 248, and user controls 250 in the example shown in FIG. 2. The display can output an image of the user so users are able to view themselves during a communication event. The server 206 generates user prompts or feedback that can be displayed on the output display 246 or output at the audio output 248. The audio can be a speaker in some examples. For example, if the user is speaking too quickly, the verbal content module 238 generates a user prompt and an audio indicator for the user to slow down speech. The user prompt might include a visual or tactical prompt or reminder and the audio output can include a beep or buzz to quickly and discretely prompt the user to slow down. Any combination can also be used. The user interface 208 also includes a set of user controls 250 in some examples. The user controls receive input from a user to input data or otherwise interact with any component of the communication skills training system 200.

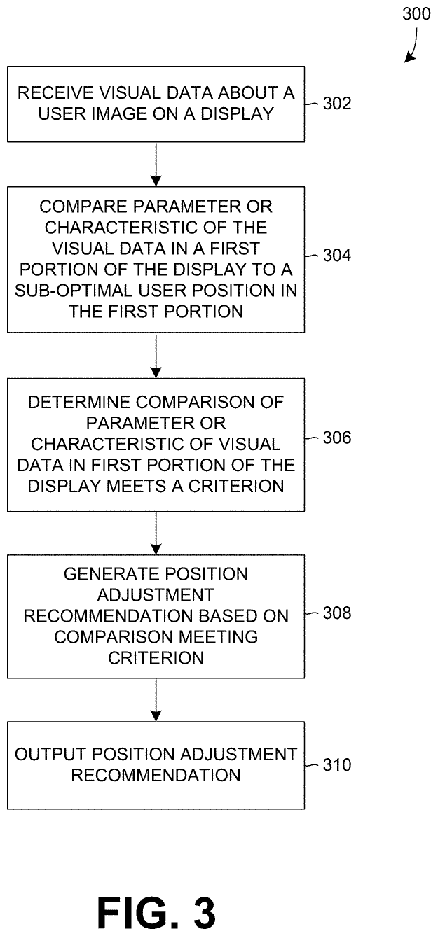

In an example, the communication skills training system can help a user align themselves with on a display. The display can be a virtual display in some examples or can be a communication event live environment. The virtual display can include a screen in some examples. FIG. 3 shows a method of aligning a user on a display 300 that receives visual data about a user image on a display 302. The received visual data has certain parameters or characteristics. The parameter(s) or characteristic(s) are compared to one or more sub-optimal parameter(s) or characteristic(s) 304. For example, a parameter of the user's image in a first portion of the display is compared to a sub-optimal position of the user in the first portion of the display 304. Alternatively, the parameter of the user's image in the first portion of the display can also be compared to one or more optimal parameter(s) or characteristic(s). In the example shown in FIG. 3, the comparison of the parameter or characteristic of the user's image in the first portion of the display (the visual data) is determined to meet a criterion 306, such as comparing the user's position to a sub-optimal position of the user in the first portion of the display.

Some portions of the display may have different criterion than others. For example, a user may ideally want their head to be centered in a central portion of the display, not positioned too far to the left or right within the display. A camera or other optical imaging device detects the user's position within the central portion of the display. A sub-optimal user position in the central portion would include, for example, the user's body not appearing or only partially appearing (below a measured threshold) in the central portion. The criterion to be met by the user in the central portion is that the user is detected to be physically located in greater than a majority or certain percentage (e.g., −80%) of the central portion. If the user is positioned properly, then the comparison of the user's position in the central portion to the sub-optimal position would not be determined to meet the criterion. However, if the user is not centrally positioned and is instead askew to the right or left exceeding the respective display portion threshold, then the criterion is met. In this example, a position adjustment recommendation is generated 308 based on the comparison meeting the criterion—the user is not centrally positioned. The position adjustment recommendation is then output 310 to the user, a third party, the system content analysis algorithm, or some combination. The output can be in real-time in some examples or asynchronously in other examples.

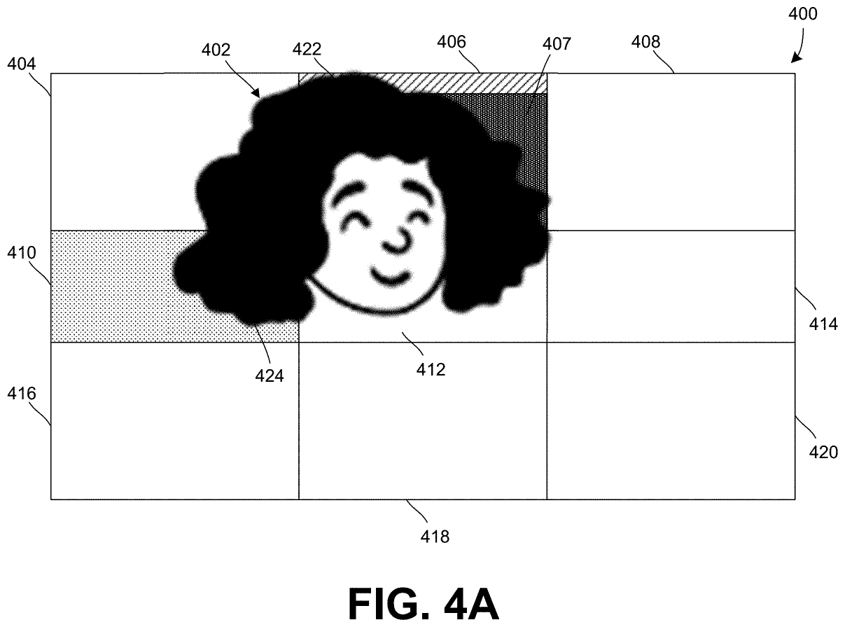

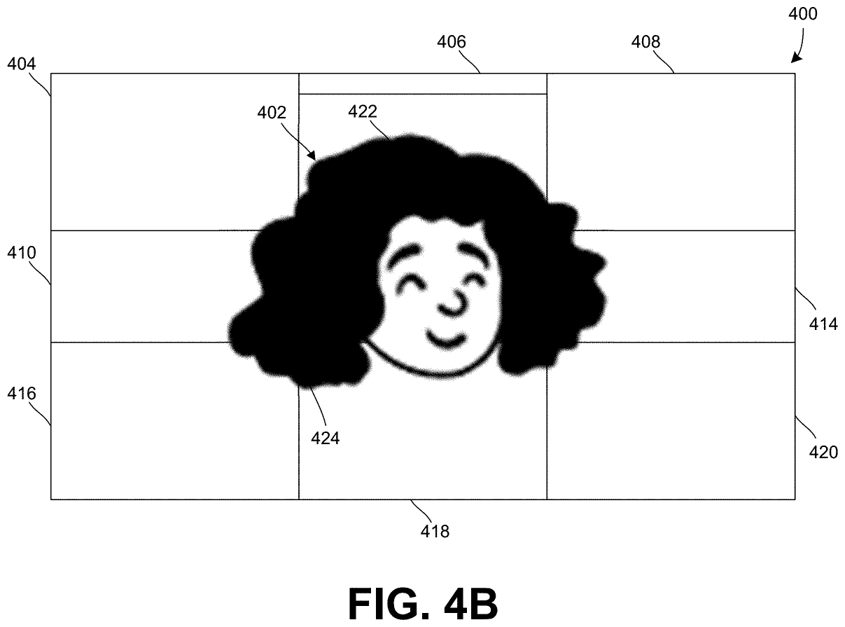

FIGS. 4A and 4B show an example system that helps users position themselves on a display or screen 400. The user 402 positioned in a sub-optimal position in FIG. 4A and an optimal position in FIG. 4B on a display 400. In this example, the display 400 includes 10 display portions—a top left display portion 404, a head space display portion 406, a top middle display portion 407, a top right display portion 408, a middle left display portion 410, a center display portion 412, a middle right display portion 414, a bottom left display portion 416, a bottom middle display portion 418, and a bottom right display portion 420. Each portion of the display includes a respective number of pixels. The number of pixels in each portion can be the same in all portions of the display in some examples. In other examples, such as the example shown in FIGS. 4A and 4B, the number of pixels in one or more portions of the display can differ. In still other examples, every portion of the display has a different number of pixels associated with it.

In the example shown in FIGS. 4A and 4B, a first sub-set of display portions 404, 408, 416, 418, and 420 has the same number of pixels. This first sub-set has the highest number of pixels of all of the display portions in the display 400. Display portions 410, 412, and 414 in a second sub-set have the same number of pixels, although they each have fewer pixels than the display portions 404, 408, 416, 418, and 420 of the first sub-set. One display portion 406 has the fewest number of pixels and is the only display portion with this number of pixels. Each of the portions has an ideal and a sub-optimal number of pixels in which a user image should or should not be positioned to consume within the respective display portion.

An optimal or sub-optimal position can be determined by any objective or subjective criteria. An optimal position, for example, could be set as a position of the user within a central portion of the display with 70% of the user's face positioned in the central display portion 412. The optical imaging device could identify the user's face and its detected perimeter to discern between the user's face and hair. It then then determines if at least 70% of the user's face is positioned within the central display portion 412. The user's face is positioned askew of the central portion 412 in FIG. 4A. The percentage of the user's face in the central display portion 412 is below the 70% threshold. In some examples, the system outputs a user prompt or alert to reposition and highlights or outputs a prompt—such as illuminating the display portion a different color. The user 402 shown in FIG. 4A is not positioned to have 70% of their face in the pixels of the central portion 412 as is set to be the optimal position of the user image in the central display portion 412, but in this example, the central display portion 412 is not highlighted. Instead, the top middle portion 407 is highlighted because the user's face is detected as consuming too many of the top middle portion 407 pixels or simply too great of a percentage of the top middle display portion 407. In this example, the user 402 has approximately 50% of their face positioned in the top middle display portion 407, which is sub-optimal so the top middle display portion 407 is highlighted to alert the user to re-position themselves to a lower position in the display—to cause the user's face to consume fewer pixels in the top middle display portion 407.

Notably, the example shown in FIG. 4A does not have the central display portion highlighted. The system can be configured to only identify and highlight display portions in which any portion of the user's image appears to exceed an optimal percentage of the display portion or an optimal number of pixels in the respective display portion. The central portion can be configured to never be highlighted for this reason but could be highlighted by a different color or other prompt type when the user image is not properly positioned in the central display portion 412, in other examples. By highlighting the display portions when any portion of the user image consumes pixels or a percentage of the display portion that exceeds a threshold value, the display portions are highlighted surrounding the user image as a type of highlighted perimeter that guides the user to position themself back to an optimal position. The surrounding display portions remain highlighted until the user no longer exceeds the threshold in that perimeter display portion surrounding the user image.

Additionally or alternatively, multiple display portions could be evaluated for user position. For example, the user in FIG. 4A has approximately 50% of their face in the top middle display portion 407 and 50% of their face in the central display portion 412. The sub-optimal position of the user's face in both of these display portions 407, 412 generates a position adjustment recommendation to the user, as discussed above. Additionally, the user's hair 422 is detected in the head space display portion 406. The head space display portion 406 is highlighted in FIG. 4A because no portion of the user's image optimally appears in the head space display portion 406 when the user is positioned in an optimal vertical alignment. The head space display portion 406 is smaller than all of the other display portions 404, 407, 408, 410, 412, 424, 416, 418, and 420. In the example shown in FIG. 4A, the head space portion should remain free of any portion of the user's image according to conventional expert advice to speakers presenting on a screen display. In alternative examples, some smaller portion of the head space display portion 406 can include the user's image if the user is detected to be large but otherwise positioned correctly. However, most often when a portion of the user's image appears in the head space display portion 406, the user 402 is either too close to the optical imaging device and appears too large on the display or the user 402 is vertically misaligned, both of which generate a prompt to adjust the user's position.

In FIG. 4A, a third display portion is evaluated and highlighted as a result of the user's misaligned position. The left middle display portion 410 is highlighted because the user's hair appears in too many pixels or in too great of a percentage. As with the other display portions, the number of pixels or percentage of the left middle display portion 410 consumed by the user's image is compared to the user's overall position including the size, shape, contour, or volume of a user's hair, for example. As shown in FIG. 4A, the user has a portion of their hair 424 that appears in the left middle display portion 410 above a threshold percentage or pixel value. Thus, the left middle display portion 410 is highlighted to prompt the user 402 to move to a more central location within the display. The user's image can be evaluated by the communication training skills system to identify size, shape, contour, or volume or any portion of or the entire user image. In some examples, the user's image is analyzed to identify ratios between the portion of the user image consumed by the user's face and the portion of the user's image consumed by the user's hair, which can vary dramatically among users. The system aligns or adjusts the expected threshold of percentages or pixels volume consumed by the user's image or some portion of it based on this calculated ratio.

The communication skills training system can also receive input user data regarding the user's size, shape, contour, or other image characteristics or parameters. For example, the user can input text to describe themselves or can input a sample photo or video of the user from which the system calculates baseline data about the user's general physical features. The system then adjusts ratios based on the parameters or characteristics of the input data, such as the ratio of face to hair, the size of the user's face, and the like.

In the example system shown in FIG. 4A, parameters or characteristics of multiple display portions—the head space display portion 406, the top middle display portion 407, and the left middle display portion 410—are evaluated in combination with each other although they can be independently evaluated in alternative examples. Neighboring display portions have relationships with each other that cause one to exceed a threshold while another falls below a threshold, both the result of the same misalignment of the user. In this example, the parameter or characteristic of multiple display portions are evaluated. FIG. 4A shows the parameters or characteristics of the respective multiple display portion are analyzed or compared to a sub-optimal position of the user 402—in this example, the sub-optimal portion of the user 402 is defined as the image of the user 402 consuming too great of a percentage or too many pixels within the head space display portion 406, the top middle display portion 407, and the left middle display portion 410. In this example, the top left display portion 404 is not highlighted because the percentage or number of pixels consumed by the user's image does not exceed the threshold value assigned to the top display portion 404. The threshold set for each display portion can differ or some display portions can have the same threshold values.

Values are discussed above in reference to FIG. 4A for clarity. However, ranges can also be used as well as tolerances with a value or range can be used to determine whether the user's image or a portion of it is misaligned in a particular display portion.

FIG. 4B shows a user 402 in an optimal position on the display 400. In this example, none of the display portions are highlighted or illuminated because each has a portion of the user's image below its respective threshold value.

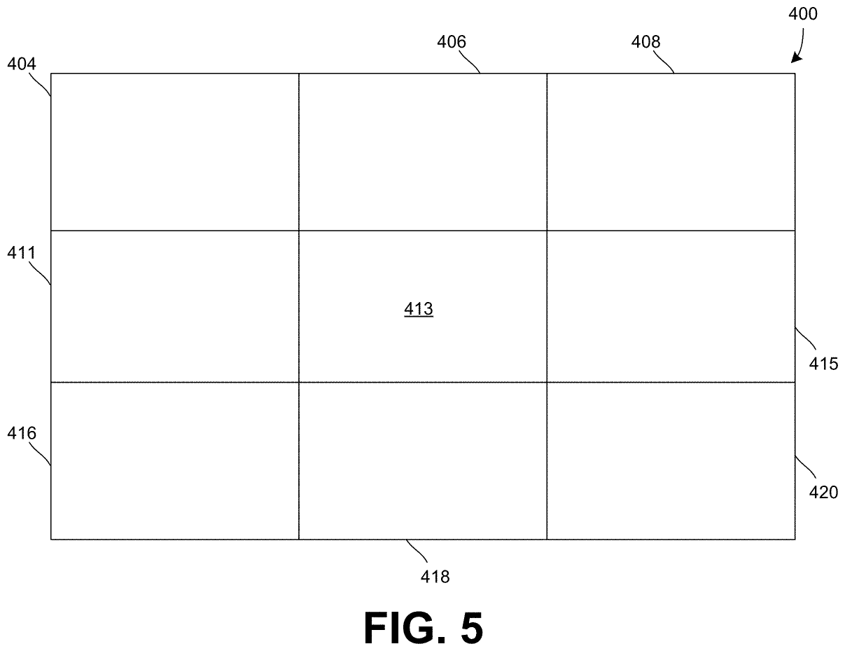

FIG. 5 shows another example display 400 without a user image. Each of the display portions 404, 406, 408, 410, 412, 414, 416, 418, and 420 in this example display 400 are the same size, i.e., each includes the same number of pixels.

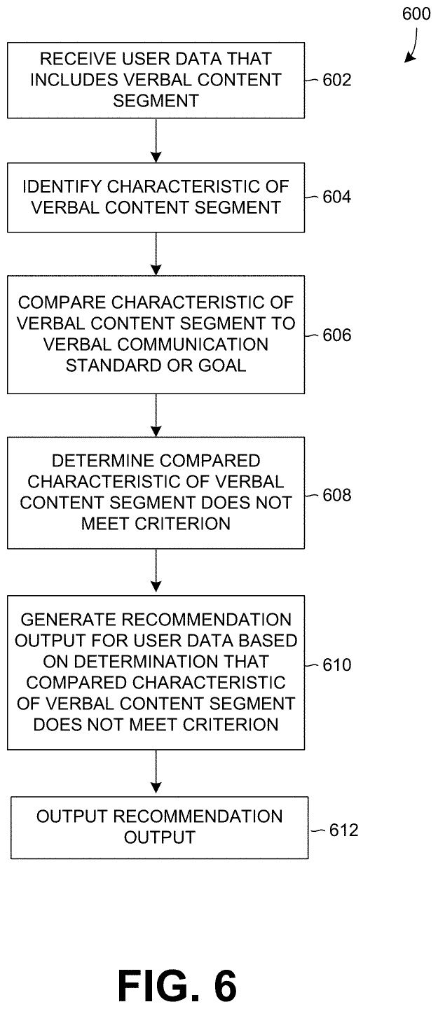

Turning now to FIG. 6, a method of training users to improve communication skills 600 includes receiving using data that includes a verbal content segment 602. As discussed above, the verbal content segment can be received during or after a communication event. The method 600 also identifies a characteristic of the verbal content segment 604, such as the user's word choice like non-inclusive language, disfluenc(ies), jargon, and top key word(s). The identified characteristic can be any parameter or characteristic of the user's verbal content. Additionally, the method 600 can include identifying a parameter or characteristic of a user's qualities relating to the user data, such as voice volume, tone, and pitch and the user's speech pacing. The parameter or characteristic of the verbal content is compared to a verbal communication standard or goal 606. The verbal communication standard or goal can be determined by the user or a third party like a coach or mentor. The verbal communication standard or goal can also be determined by an objective measure, such as a comparison to a communicator who is skilled in a particular communication skill related to the standard or goal or an objective goal or standard defined by an expert communicator.

The characteristic of the verbal content segment can be determined that is does not meet a criterion 608. The criterion can be a set value, such a threshold, or a range within which the measured characteristic ideally should be. The method 600 generates recommendation output based on the characteristic of the verbal content segment being determined not to meet a criterion 608. The output can relate to suggested or recommended improvements to the characteristic of the verbal content segment or a related characteristic. The recommendation output is then output 612, such as to the user or a third party. The recommendation output can be transmitted to a display or a third party, for example.

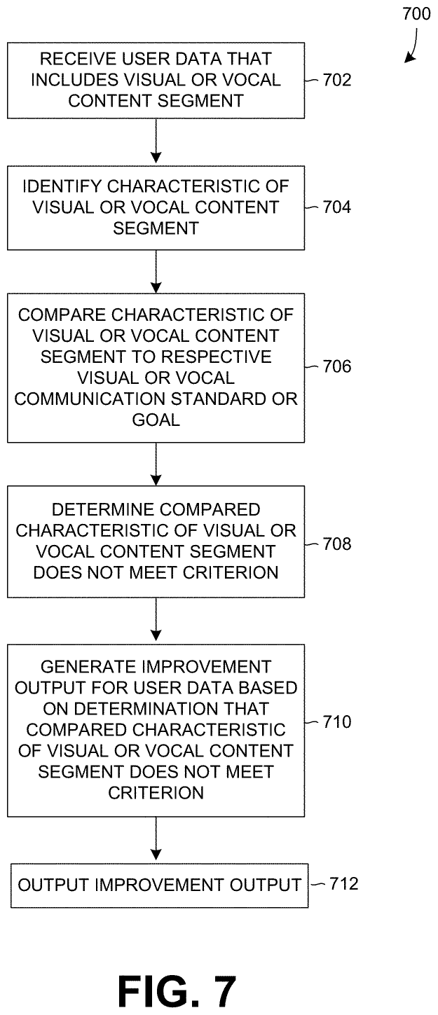

Turning now to FIG. 7, a method of training users to improve communication skills 700 includes receiving using data that includes a visual or vocal content segment 702. As discussed above, the visual or vocal content segment can be received during or after a communication event. The method 700 also identifies a characteristic of the visual or vocal content segment 704. The identified characteristic can be any parameter or characteristic of the user's visual or vocal content. In some examples, the visual content includes the user's body language or physical position, posture, composure, habits, and the like of the user. Vocal content includes features or characteristics of the user's voice, such as tone, pitch, and volume or speech pacing.

The parameter or characteristic of the visual or vocal content is compared to a visual or vocal content communication standard or goal 706. The visual or vocal communication standard or goal can be determined by the user or a third party like a coach or mentor. The visual or vocal communication standard or goal can also be determined by an objective measure, such as a comparison to a communicator who is skilled in a particular communication skill related to the standard or goal or an objective goal or standard defined by an expert communicator.

The characteristic of the visual or vocal content segment can be determined that it does not meet a criterion 708. The criterion can be a set value, such a threshold, or a range within which the measured characteristic ideally should be. The method 700 generates recommendation output based on the characteristic of the visual or vocal content segment being determined not to mee a criterion 708. The output can relate to suggested or recommended improvements to the characteristic of the visual or vocal content segment or a related characteristic. The recommendation output is then output 712, such as to the user or a third party. The recommendation output can be transmitted to a display or a third party, for example.

In some examples, the user data can include both visual content and vocal content. The visual content and vocal content are compared against respective characteristics of visual and vocal content standards or goals. If one or both of those comparisons are determined not to meet a criterion, then the improvement output is generated that is based on the determination that the comparison of one or both of the visual content or the vocal content did not meet their respective criterion.

Though certain elements, aspects, components or the like are described in relation to one embodiment or example, such as an example diagnostic system or method, those elements, aspects, components or the like can be including with any other diagnostic system or method, such as when it desirous or advantageous to do so.

The foregoing description, for purposes of explanation, used specific nomenclature to provide a thorough understanding of the disclosure. However, it will be apparent to one skilled in the art that the specific details are not required in order to practice the systems and methods described herein. The foregoing descriptions of specific embodiments are presented by way of examples for purposes of illustration and description. They are not intended to be exhaustive of or to limit this disclosure to the precise forms described. Many modifications and variations are possible in view of the above teachings. The embodiments are shown and described in order to best explain the principles of this disclosure and practical applications, to thereby enable others skilled in the art to best utilize this disclosure and various embodiments with various modifications as are suited to the particular use contemplated. It is intended that the scope of this disclosure be defined by the following claims and their equivalents.

1. A computer-implemented method for measuring dynamic elements of a communication event, the method comprising:
generating a data set for an artificial intelligence (AI) process from the communication event, wherein the generating includes:
receiving user data that includes a visual content segment, a verbal content segment, and a vocal content segment of the communication event;
analyzing the user data to identify particular visual, verbal, and vocal characteristics presented in the communication event and to generate metrics that quantify the particular visual, verbal, and vocal characteristics; and
generating a first data set based on the analyzing of the user data;
receiving a second data set from a user profile that is associated with the communication event;
incorporating the first data set and the second data set into the AI process to generate a computer-based analysis of the communication event, the generating based, at least in part, on differences between the first data set and the second data set; and
updating the user profile with the first data set.

2-4. (canceled)

5. The method of claim 1, wherein the visual content segment includes body language or physical position, composure, or habits of a user corresponding to the user profile, wherein the user performed the communication event.

6. The method of claim 5, wherein the vocal content segment includes tone, pitch, or loudness of the user.

7. The method of claim 27, wherein the recommendation output is output during the communication event.

8. The method of claim 1, wherein the visual content segment and the vocal content segment are received during the communication event.

9. The method of claim 27, wherein the recommendation output is output after the communication event.

10. The method claim 1, wherein the visual content segment and the vocal content segment are received after the communication event.

11. The method of claim 27, wherein the criterion comprises a communication standard or goal.

12. The method of claim 27, wherein the criterion comprises a communication goal received from the user.

13. The method of claim 27, wherein the criterion comprises an expert communication standard or goal.

14. The method of claim 27, wherein generating the recommendation output for the user data includes a recommendation to adjust an aspect of the particular visual or vocal characteristics.

15. The method of claim 27, further comprising generating, based at least in part on the computer-based analysis of the communication event, a simulated interactive response to the communication event based on the determining that the characteristic does not meet the criterion.

16. The method of claim 15, wherein generating the simulated interactive response includes causing an avatar to have a visual appearance consistent with the determining that the characteristic does not meet the criterion.

17. The method of claim 1, wherein video frames of the communication event are mapped to frames of a prior communication event, and wherein the mapped frames of the communication event are compared to correlate frames of the prior communication event to identify whether the characteristic does not meet the criterion.

18. The method of claim 17, wherein the mapping of the frames of the communication event to the prior communication event are time-stamped or mapped based on verbal content in each of the communication event and the prior communication event.

19. A system for measuring dynamic elements of a communication event, the system comprising:
a processor that is configured to:
generate a data set for an artificial intelligence (AI) process from the communication event by
receiving user data that includes a visual content segment, a verbal content segment, and a vocal content segment of the communication event;
analyzing the user data to identify particular visual, verbal, and vocal characteristics presented in the communication event and to generate metrics that quantify the particular visual, verbal, and vocal characteristics; and
generating a first data set based on the analyzing of the user data;
receive a second data set from a user profile that is associated with the communication event;
incorporate the first data set and the second data set into the AI process to generate a computer-based analysis of the communication event, the generating based, at least in part, on differences between the first data set and the second data set; and
update the user profile with the first data set; and
an output configured to output the computer-based analysis.

20. The system of claim 28, wherein the processor is further configured to generate the recommendation output during the communication event.

21. The system of claim 28, wherein the processor is further configured to generate the recommendation output after the communication event.

22. The system of claim 28, wherein the criterion comprises i) a communication standard or ii) a goal provided by a user that corresponds to the user profile.

23. The system of claim 28, wherein the processor is further configured to compare the characteristic to a communication standard or goal provided by a third party.

24. The system of claim 28, wherein the processor is further configured to compare the characteristic to an expert communication standard or goal.

25. The system of claim 28, wherein the processor is further configured to generate a simulated interactive response based on the determination that the characteristic does not meet the criterion.

26. The system of claim 25, wherein the processor is further configured to generate the simulated interactive response to include causing an avatar to have a visual appearance consistent with the determination that the characteristic does not meet the criterion.

27. The method of claim 1, further comprising:
selecting a characteristic from among the particular visual, verbal, and vocal characteristics to compare the characteristic to a communication standard or goal;
based on the comparing, determining that the characteristic does not meet a criterion;
generating recommendation output for the user data, the generating based on the determining that the characteristic does not meet the criterion; and
outputting the recommendation output.

28. The system of claim 19, wherein the processor is further configured to:
select a characteristic from among the particular visual, verbal, and vocal characteristics to compare the characteristic to a communication standard or goal;
based on the comparing, determine that the characteristic does not meet a criterion; and
generate recommendation output for the user data, the generating based on the determining that the characteristic does not meet the criterion.
